(19) United States
(12) Patent Application Publication
(10) Pub. No.: US 2026/0350439 A1
(43) Pub. Date: Nov. 5, 2026

(54) Governed Associative Memory-Body Constitution Systems and Methods for Transforming Mission-Governed Raw Information into Associative Memory Bodies and Executable Experience Structures

(71) Applicant: Xinxin Shan, Surrey (CA)

(72) Inventor: Xinxin Shan, Surrey (CA)

(73) Assignee: LED Smart Inc, Surrey, BC (CA)

(21) Appl. No.: 19/709,720

(22) Filed: Jun. 16, 2026

(51) Int. Cl. G06N 5/04; G06N 5/022

(52) U.S. Cl. CPC G06N 5/04; G06N 5/022

(57) ABSTRACT

A mission-governed associative memory-body constitution system receives one or more raw information structures and determines one or more mission structures and mission boundaries associated with the raw information structures. Participation structures are determined according to the mission boundaries and representative information structures are formed according to the participation structures. Identity structures, state structures, relationship structures, and attribute structures are constituted from the representative information structures. Verification structures and qualification structures are determined according to the constituted structures. One or more governed associative memory bodies are constituted according to the verification structures and qualification structures. Associative memory bodies may participate in associative memory meshes, memory activation relationships, memory reuse relationships, and executable experience constitution relationships. The disclosed architecture transforms mission-governed raw information into reusable governed memory and executable experience structures.

### CROSS-REFERENCE TO RELATED APPLICATIONS

This application claims priority to and incorporates by reference all subject matter disclosed in any related provisional applications, non-provisional applications, continuation applications, continuation-in-part applications, divisional applications, foreign applications, international applications, and patent documents owned by the Applicant and associated with mission-governed information constitution, memory constitution, associative memory formation, memory activation, memory reuse, executable experience constitution, governance-conditioned participation determination, qualification determination, verification determination, or combinations thereof.

### PRIOR ART

The following references are provided as prior art references for information disclosure purposes. Inclusion of any reference does not constitute an admission that the reference is material, relevant, analogous, enabling, anticipatory, obvious, or otherwise applicable to any claim of the present application.

The listed references are provided to assist review of technologies associated with mission determination, goal-oriented systems, participation determination, representative information formation, knowledge representation, knowledge graphs, associative memory, memory retrieval, memory-augmented artificial intelligence, case-based reasoning, continual learning, provenance systems, verification systems, qualification systems, reasoning systems, recommendation systems, experience-based systems, artificial-intelligence systems, machine-learning systems, and related operational infrastructures.

The Applicant expressly reserves the right to distinguish, amend, supplement, remove, replace, combine, or otherwise address any reference during prosecution.

The references are listed in a neutral disclosure format and are not presented in any order of relevance, materiality, chronology, similarity, importance, or applicability.

US PATENT DOCUMENTS

| | |
|---|---|
| U.S. Pat. No. 9,882,833 B2 | January 2018 Mcbride et al. |
| U.S. Pat. No. 10,250,525 B2 | April 2019 Mcbride et al. |
| U.S. Pat. No. 10,673,777 B2 | June 2020 Mcbride et al. |
| U.S. Pat. No. 10,862,822 B2 | December 2020 Bugenhagen et al. |
| U.S. Pat. No. 11,544,470 B2 | January 2023 Zhang et al. |
| U.S. Pat. No. 10,203,701 B2 | February 2019 Kurdi et al. |
| US 2012/0158633 A1 | June 2012 Eder |
| U.S. Pat. No. 11,238,065 B1 | February 2022 Tang |
| U.S. Pat. No. 10,956,510 B2 | March 2021 Boxwell et al. |
| U.S. Pat. No. 11,531,817 B2 | December 2022 Aditya et al. |
| US 2022/0245470 A1 | August 2022 Acharya et al. |
| US 2023/0267338 A1 | August 2023 Kotnis et al. |
| U.S. Pat. No. 11,645,095 B2 | May 2023 Kumar et al. |
| U.S. Pat. No. 11,216,444 B2 | January 2022 Busjaeger et al. |
| U.S. Pat. No. 10,007,674 B2 | June 2018 Fink et al. |
| U.S. Pat. No. 9,996,595 B2 | June 2018 Bond |
| US 20160164884 A1 | June 2016 Sriram et al. |
| US 2021/0319340 A1 | October 2021 Shabtay et al. |
| U.S. Pat. No. 11,615,331 B2 | March 2023 Li et al. |
| US 2018/0330238 A1 | November 2018 Luciw et al. |
| U.S. Pat. No. 11,836,600 B2 | December 2023 Baker et al. |
| U.S. Pat. No. 12,205,010 B2 | January 2025 Baker et al. |
| U.S. Pat. No. 11,948,063 B2 | April 2024 Baker et al. |
| U.S. Pat. No. 11,003,865 B1 | May 2021 Lee et al. |
| US 2024/0346256 A1 | October 2024 Qin |
| U.S. Pat. No. 10,007,513 B2 | June 2018 Malladi et al. |
| U.S. Pat. No. 5,253,328 A | October 1993 Hartman |
| U.S. Pat. No. 5,581,664 A | December 1996 Allen et al. |
| U.S. Pat. No. 6,212,528 B1 | April 2001 Brophy et al. |
| U.S. Pat. No. 7,739,208 B2 | June 2010 George et al. |
| U.S. Pat. No. 9,530,091 B2 | December 2016 Hawkins et al. |
| U.S. Pat. No. 9,477,655 B2 | October 2016 Pestian et al. |
| US 2015/0235135 A1 | August 2015 Shastri et al. |
| U.S. Pat. No. 10,885,426 B2 | January 2021 Santoro et al. |
| US 2021/0389881 A1 | December 2021 Bhunia et al. |

### BACKGROUND OF THE INVENTION

The present disclosure relates generally to information processing, memory constitution, and operational knowledge formation.

Conventional information-processing systems, database systems, knowledge-graph systems, artificial-intelligence systems, machine-learning systems, and decision-support systems frequently process large quantities of information without first determining mission-governed participation relationships associated with the information.

As a result, information may participate in operational reasoning, planning, prediction, assessment, recommendation, guidance, control, or decision-support activities despite lacking mission relevance, qualification, admissibility, verification, or governance compatibility.

Existing systems often treat information storage, information retrieval, and information processing as equivalent to memory formation. However, information, states, relationships, attributes, and memory may represent constitutionally different structures.

Furthermore, artificial-intelligence outputs, generated outputs, inferred outputs, and predicted outputs may exhibit uncertainty, inconsistency, contradiction, mission incompatibility, boundary incompatibility, qualification incompatibility, verification incompatibility, or combinations thereof.

Accordingly, a need exists for systems and methods capable of transforming mission-governed raw information into governed associative memory bodies and executable experience structures according to mission structures, mission boundaries, participation relationships, verification relationships, qualification relationships, and governance relationships.

### SUMMARY OF THE INVENTION

The present disclosure provides systems and methods for mission-governed associative memory-body constitution.

In some embodiments, one or more mission structures are determined according to one or more raw information structures. One or more mission boundaries are determined according to the one or more mission structures. One or more participation structures are determined according to the one or more mission boundaries. One or more representative information structures are formed according to the participation structures.

One or more identity structures, state structures, relationship structures, and attribute structures are constituted according to the representative information structures. One or more verification structures and qualification structures are determined according to the constituted structures.

One or more governed associative memory bodies are constituted according to the verification structures and qualification structures. One or more associative memory meshes may be formed from multiple associative memory bodies. One or more executable experience structures may be constituted according to associative memory bodies, associative memory meshes, memory activation relationships, memory reuse relationships, or combinations thereof.

The disclosed architecture enables mission-governed transformation of raw information into reusable operational knowledge while reducing participation of unverified, unqualified, mission-incompatible, boundary-incompatible, or otherwise inadmissible information.

### BRIEF DESCRIPTION OF DRAWINGS

FIG. 1—Mission-Governed Participation and Representative-Information Constitution Architecture

FIG. 2—State and Relationship Constitution Architecture

FIG. 3—Memory-Derived Attribute Constitution Architecture

FIG. 4—Verification and Qualification Determination Architecture

FIG. 5—Governed Associative Memory-Body Constitution Architecture

FIG. 6—Associative Memory Mesh Architecture

FIG. 7—Executable Experience Constitution Architecture

FIG. 8—Mission-Governed Raw Information to Executable Experience Architecture

### DETAILED DESCRIPTION OF THE INVENTION

The figures described herein illustrate example constitutional structures associated with a governed associative memory-body constitution architecture.

The figures are provided for explanatory purposes and do not limit the scope of the invention.

Structures 101-107 and structures 111-118 operate together as an inseparable mission-governed associative memory-body constitution architecture.

The disclosed architecture shall not be interpreted as requiring separation of mission determination, mission-boundary determination, participation determination, representative-information formation, identity constitution, state constitution, relationship constitution, attribute constitution, verification determination, qualification determination, associative-memory constitution, executable-experience constitution, memory-boundary governance, associative-memory governance, executable-experience governance, or related constitutional structures.

Governed associative memory-body participation authority is established according to mission-governed participation relationships, qualification relationships, verification relationships, and boundary relationships, and not solely according to information availability, communication connectivity, storage availability, artificial-intelligence generation, computational origin, operational origin, or combinations thereof.

The disclosed figures illustrate constitutional relationships rather than operational sequences.

The disclosed architecture defines mission-governed associative memory-body constitution among heterogeneous information domains, memory domains, operational domains, software domains, hardware domains, human domains, artificial-intelligence domains, organizational domains, infrastructure domains, and future domains operating within governed operational ecosystems.

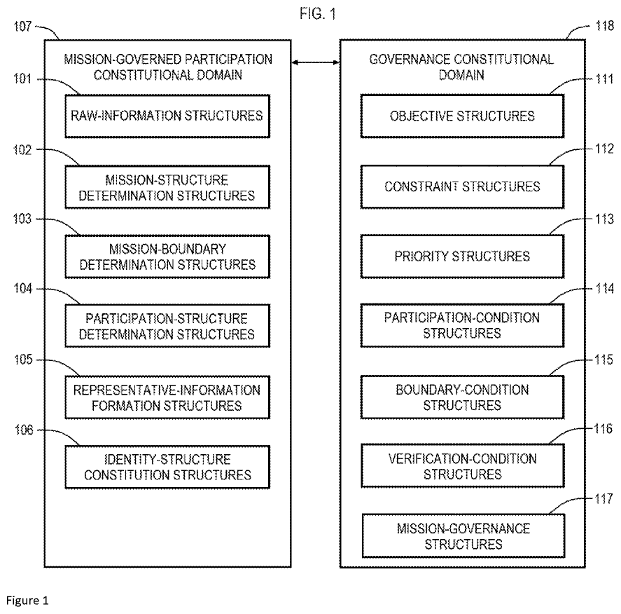

FIG. 1 illustrates a mission-governed participation and representative-information constitution architecture.

Structure 107 defines a mission-governed participation constitutional domain configured to contain raw-information structures, mission structures, mission-boundary structures, participation structures, representative-information structures, and identity structures.

Structure 101 defines raw-information structures configured to receive one or more raw information structures.

Structure 102 defines mission-structure determination structures configured to determine one or more mission structures associated with the one or more raw information structures.

Structure 103 defines mission-boundary determination structures configured to determine one or more mission boundaries according to the one or more mission structures.

Structure 104 defines participation-structure determination structures configured to determine one or more participation structures according to the one or more mission boundaries.

Structure 105 defines representative-information formation structures configured to form one or more representative information structures according to the one or more participation structures.

Structure 106 defines identity-structure constitution structures configured to constitute one or more identity structures associated with the representative information structures.

Structure 118 defines a governance constitutional domain configured to contain mission governance structures associated with mission-governed participation relationships.

Structures 111-117 respectively define objective structures, constraint structures, priority structures, participation-condition structures, boundary-condition structures, verification-condition structures, and mission-governance structures.

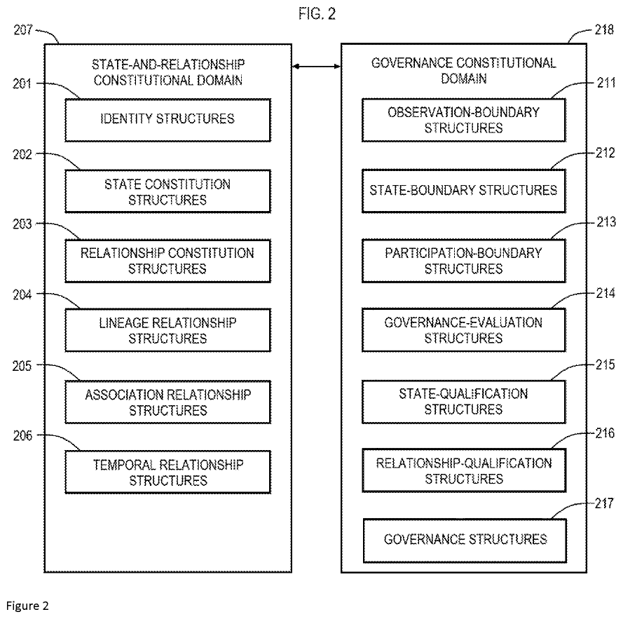

FIG. 2 illustrates a state and relationship constitution architecture.

Structure 207 defines a state-and-relationship constitutional domain configured to contain identity structures, state structures, relationship structures, lineage structures, association structures, and temporal structures.

Structure 201 defines identity structures.

Structure 202 defines state constitution structures configured to constitute one or more state structures associated with the identity structures.

Structure 203 defines relationship constitution structures configured to constitute one or more relationship structures associated with the state structures.

Structure 204 defines lineage relationship structures.

Structure 205 defines association relationship structures.

Structure 206 defines temporal relationship structures.

Structure 218 defines a governance constitutional domain configured to contain governance structures associated with state and relationship participation.

Structures 211-217 respectively define observation-boundary structures, state-boundary structures, participation-boundary structures, governance-evaluation structures, state-qualification structures, relationship-qualification structures, and governance structures.

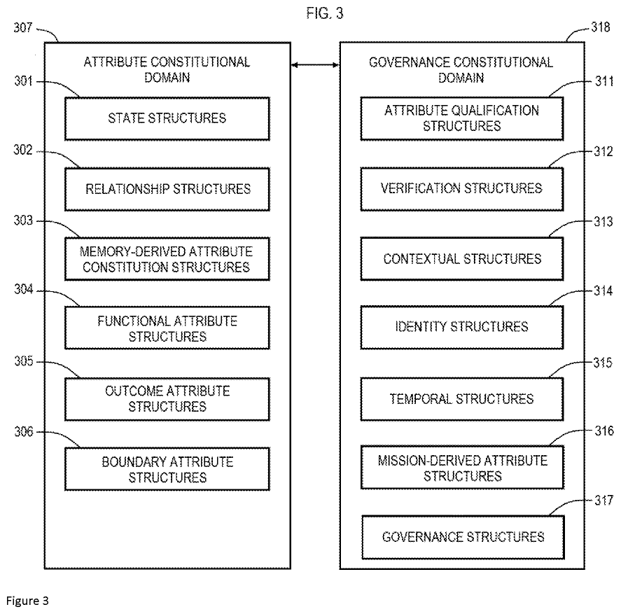

FIG. 3 illustrates a memory-derived attribute constitution architecture.

Structure 307 defines an attribute constitutional domain configured to contain state structures, relationship structures, attribute structures, functional attributes, outcome attributes, and boundary attributes.

Structure 301 defines state structures.

Structure 302 defines relationship structures.

Structure 303 defines memory-derived attribute constitution structures configured to constitute one or more attribute structures according to the state structures and relationship structures.

Structure 304 defines functional attribute structures.

Structure 305 defines outcome attribute structures.

Structure 306 defines boundary attribute structures.

Structure 318 defines a governance constitutional domain configured to contain governance structures associated with attribute constitution relationships.

Structures 311-317 respectively define attribute qualification structures, verification structures, contextual structures, identity structures, temporal structures, mission-derived attribute structures, and governance structures.

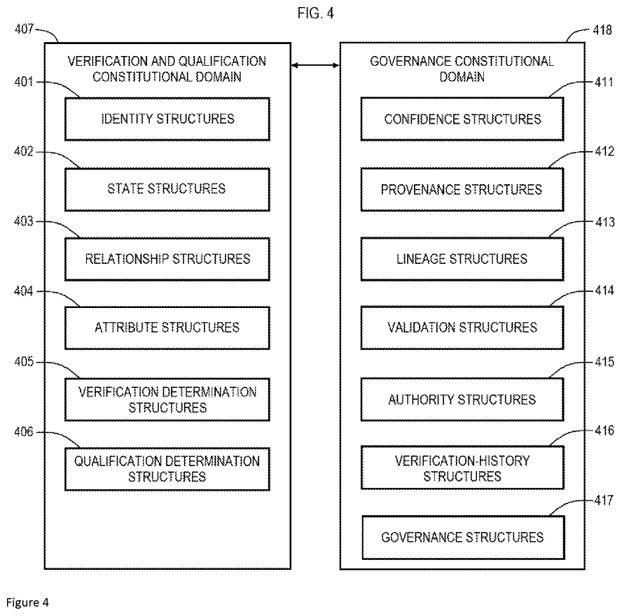

FIG. 4 illustrates a verification and qualification determination architecture.

Structure 407 defines a verification and qualification constitutional domain configured to contain identity structures, state structures, relationship structures, attribute structures, verification structures, and qualification structures.

Structure 401 defines identity structures.

Structure 402 defines state structures.

Structure 403 defines relationship structures.

Structure 404 defines attribute structures.

Structure 405 defines verification determination structures configured to determine one or more verification structures.

Structure 406 defines qualification determination structures configured to determine one or more qualification structures according to the verification structures.

Structure 418 defines a governance constitutional domain configured to contain governance structures associated with verification and qualification relationships.

Structures 411-417 respectively define confidence structures, provenance structures, lineage structures, validation structures, authority structures, verification-history structures, and governance structures.

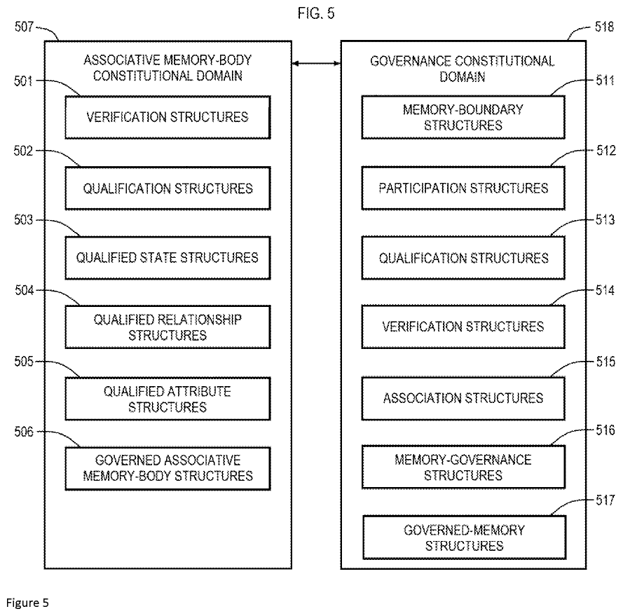

FIG. 5 illustrates a governed associative memory-body constitution architecture.

Structure 507 defines an associative memory-body constitutional domain configured to contain verification structures, qualification structures, qualified state structures, qualified relationship structures, qualified attribute structures, and governed associative memory bodies.

Structure 501 defines verification structures.

Structure 502 defines qualification structures.

Structure 503 defines qualified state structures.

Structure 504 defines qualified relationship structures.

Structure 505 defines qualified attribute structures.

Structure 506 defines governed associative memory-body structures.

Structure 518 defines a governance constitutional domain configured to contain governance structures associated with associative memory-body constitution relationships.

Structures 511-517 respectively define memory-boundary structures, participation structures, qualification structures, verification structures, association structures, memory-governance structures, and governed-memory structures.

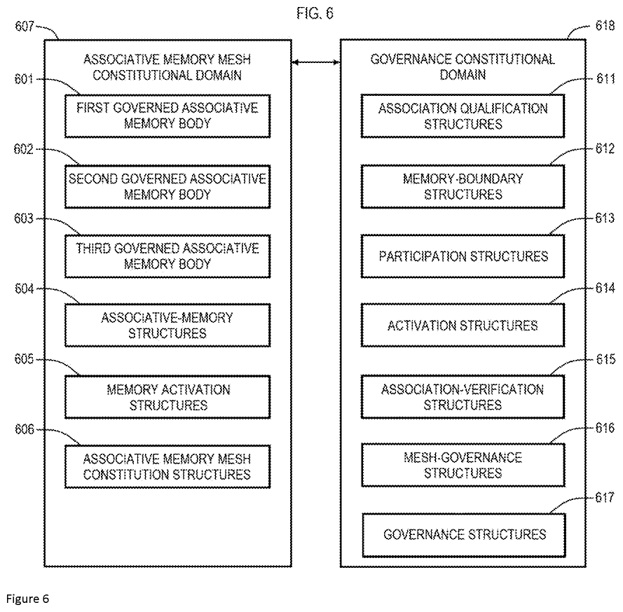

FIG. 6 illustrates an associative memory mesh architecture.

Structure 607 defines an associative memory mesh constitutional domain configured to contain governed associative memory bodies, associative-memory structures, memory activation structures, and associative memory mesh constitution structures.

Structure 601 defines a first governed associative memory body.

Structure 602 defines a second governed associative memory body.

Structure 603 defines a third governed associative memory body.

Structure 604 defines associative-memory structures.

Structure 605 defines memory activation structures.

Structure 606 defines associative memory mesh constitution structures.

Structure 618 defines a governance constitutional domain configured to contain governance structures associated with associative-memory relationships.

Structures 611-617 respectively define association qualification structures, memory-boundary structures, participation structures, activation structures, association-verification structures, mesh-governance structures, and governance structures.

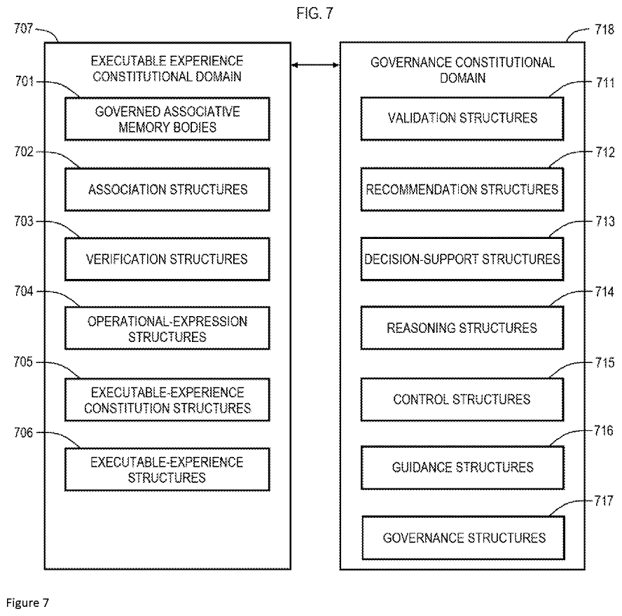

FIG. 7 illustrates an executable experience constitution architecture.

Structure 707 defines an executable experience constitutional domain configured to contain governed associative memory bodies, association structures, verification structures, operational-expression structures, executable-experience constitution structures, and executable-experience structures.

Structure 701 defines governed associative memory bodies.

Structure 702 defines association structures.

Structure 703 defines verification structures.

Structure 704 defines operational-expression structures configured to generate one or

more operational expressions according to one or more governed associative memory bodies, association structures, verification structures, or combinations thereof.

Structure 705 defines executable-experience constitution structures.

Structure 706 defines executable-experience structures.

Structure 718 defines a governance constitutional domain configured to contain governance structures associated with executable-experience relationships.

Structures 711-717 respectively define validation structures, recommendation structures, decision-support structures, reasoning structures, control structures, guidance structures, and governance structures.

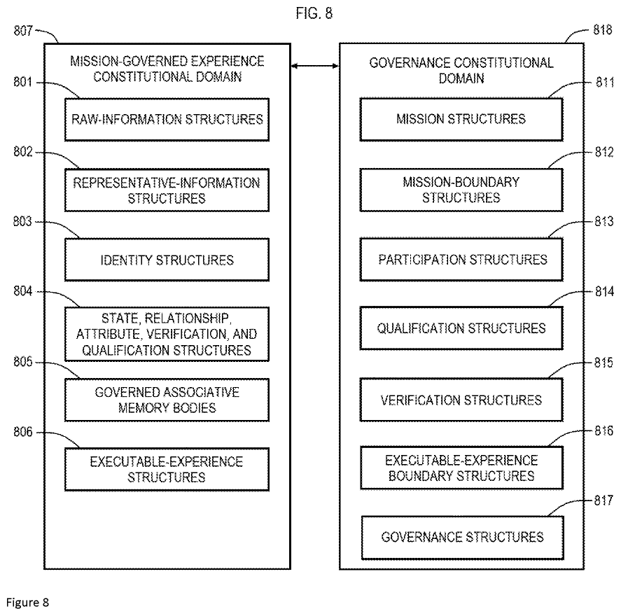

FIG. 8 illustrates a mission-governed raw information to executable experience architecture.

Structure 807 defines a mission-governed experience constitutional domain configured to contain raw-information structures, representative-information structures, identity structures, state structures, relationship structures, attribute structures, verification structures, qualification structures, governed associative memory bodies, and executable-experience structures.

Structure 801 defines raw-information structures.

Structure 802 defines representative-information structures.

Structure 803 defines identity structures.

Structure 804 defines state structures, relationship structures, attribute structures, verification structures, and qualification structures.

Structure 805 defines governed associative memory bodies.

Structure 806 defines executable-experience structures.

Structure 818 defines a governance constitutional domain configured to contain governance structures associated with mission-governed experience relationships.

Structures 811-817 respectively define mission structures, mission-boundary structures, participation structures, qualification structures, verification structures, executable-experience boundary structures, and governance structures.

The constitutional domains illustrated in FIGS. 1-8 collectively establish a governed associative memory-body constitution architecture configured to transform mission-governed raw information into governed associative memory bodies, associative-memory relationships, and executable experience structures through mission determination, boundary determination, participation determination, representative-information formation, identity constitution, state constitution, relationship constitution, attribute constitution, verification determination, qualification determination, associative-memory constitution, associative-memory relationship constitution, and executable-experience constitution relationships.

The detailed description presented herein provides example embodiments associated with mission-governed associative memory-body constitution architectures.

The disclosed embodiments are provided solely for explanatory purposes and do not limit the scope of the invention.

Unless explicitly stated otherwise, the disclosed subject matter is not limited to any particular information source, information type, information format, information quantity, information complexity, communication architecture, storage architecture, computational architecture, software architecture, hardware architecture, artificial-intelligence architecture, machine-learning architecture, reasoning architecture, memory architecture, operational environment, implementation methodology, mathematical formulation, or combinations thereof.

Mission structures disclosed herein may define one or more expected outcomes, objectives, purposes, constraints, priorities, participation conditions, operating conditions, verification conditions, boundary conditions, or combinations thereof.

Mission boundaries may be determined according to one or more mission structures and may establish admissibility relationships, participation relationships, relevance relationships, governance relationships, qualification relationships, verification relationships, or combinations thereof.

Participation within the disclosed architecture is not established solely according to information existence, information availability, information quantity, communication connectivity, storage availability, computational availability, artificial-intelligence generation, machine-learning generation, operational origin, domain origin, or combinations thereof.

One or more representative information structures may be formed from participating information structures according to mission-governed participation relationships.

Representative information structures are not necessarily associative memory bodies and may participate as memory candidates within subsequent associative memory-body constitution relationships.

Identity structures, state structures, relationship structures, attribute structures, verification structures, qualification structures, associative memory bodies, associative memory meshes, executable experience structures, and related constitutional structures may be constituted according to mission-governed participation relationships.

Verification relationships and qualification relationships are constitutionally distinct.

A structure may be verified without being qualified, qualified without participating, participating without constituting an associative memory body, or combinations thereof.

Associative memory bodies disclosed herein are governance-conditioned constitutional memory structures and are not required to be equivalent to raw information structures, database records, knowledge-graph nodes, vector representations, artificial-intelligence outputs, machine-learning outputs, isolated states, isolated relationships, isolated attributes, or combinations thereof.

Associative memory meshes may comprise one or more associative memory bodies and one or more associative relationships among the associative memory bodies.

Executable experience structures may be constituted according to associative memory bodies, associative memory meshes, memory activations, verification relationships, qualification relationships, mission relationships, governance relationships, or combinations thereof.

The disclosed architecture is not limited to any particular memory representation, memory storage methodology, memory retrieval methodology, memory activation methodology, memory association methodology, memory mesh methodology, executable-experience methodology, reasoning methodology, recommendation methodology, decision-support methodology, control methodology, or combinations thereof.

Mathematical formulations presented herein are exemplary only and are provided solely to illustrate example constitutional relationships associated with mission-governed associative memory-body constitution.

The disclosed architecture is not limited to any particular equation, function, optimization methodology, statistical methodology, machine-learning methodology, symbolic methodology, probabilistic methodology, graph methodology, ontology methodology, semantic methodology, computational methodology, or combinations thereof.

Definitions presented herein are provided to facilitate understanding of example embodiments and do not limit the scope of the invention.

The disclosed architecture encompasses alternative structures, equivalent structures, modified structures, future structures, future memory architectures, future reasoning architectures, future artificial-intelligence architectures, future associative-memory architectures, future executable-experience architectures, and combinations thereof capable of establishing mission-governed associative memory-body constitution relationships.

The detailed description that follows shall therefore be interpreted as illustrative rather than limiting.

In some embodiments, constitution of one or more governed associative memory bodies does not begin with memory formation.

Instead, constitution of one or more governed associative memory bodies begins with determination of one or more mission structures.

A mission structure may define one or more expected outcomes, objectives, purposes, constraints, priorities, participation conditions, operating conditions, verification conditions, boundary conditions, qualification conditions, or combinations thereof.

The disclosed architecture recognizes that information does not inherently possess equal constitutional significance.

Rather, constitutional significance may depend upon one or more mission structures associated with one or more operational objectives.

Accordingly, one or more mission structures may establish one or more mission boundaries configured to determine admissibility of participation of one or more information structures within subsequent associative memory-body constitution relationships.

Mission boundaries may define one or more inclusion conditions, exclusion conditions, participation conditions, verification conditions, qualification conditions, operational conditions, temporal conditions, contextual conditions, or combinations thereof.

In some embodiments, information located outside one or more mission boundaries may be excluded from participation in constitution of one or more governed associative memory bodies.

In some embodiments, information located within one or more mission boundaries may be admitted for participation in one or more associative memory-body constitution relationships.

Accordingly, identical raw information structures may constitute different associative memory bodies when evaluated according to different mission structures.

For example, one information structure may participate in constitution of a first associative memory body associated with greenhouse climate optimization, while the same information structure may not participate in constitution of a second associative memory body associated with military target identification.

Therefore, the disclosed architecture does not assume that information possesses universal memory significance.

Instead, memory significance may be determined according to mission-governed participation relationships.

The disclosed architecture therefore differs from conventional information storage architectures, database architectures, knowledge-graph architectures, and artificial-intelligence architectures that admit information without mission-governed participation determination.

Accordingly, mission determination and mission-boundary determination may occur prior to constitution of one or more governed associative memory bodies.

In some embodiments, one or more raw information structures may contain large quantities of observations, measurements, events, signals, records, expressions, sensor outputs, computational outputs, artificial-intelligence outputs, communications, documents, images, audio information, video information, operational information, or combinations thereof.

The disclosed architecture does not require direct participation of all raw information structures within associative memory-body constitution relationships.

Instead, one or more representative information structures may be formed from one or more raw information structures according to one or more mission-governed participation relationships.

Representative information structures may be formed through one or more compression operations, reduction operations, abstraction operations, clustering operations, aggregation operations, filtering operations, selection operations, summarization operations, representative-information extraction operations, representative-information formation operations, or combinations thereof.

The disclosed architecture is not limited to any specific compression algorithm, mathematical model, information-reduction technique, clustering technique, abstraction technique, artificial-intelligence technique, machine-learning technique, software architecture, hardware architecture, or implementation methodology.

In some embodiments, representative information structures preserve information determined to be relevant according to one or more mission structures while reducing participation of information determined to be non-essential for constitution of one or more associative memory bodies.

Representative information structures therefore differ from raw information structures.

However, representative information structures do not necessarily constitute associative memory bodies.

Rather, representative information structures may constitute information candidates capable of participation within subsequent identity constitution, state constitution, relationship constitution, attribute constitution, verification determination, qualification determination, associative memory-body constitution, and executable-experience constitution relationships.

Accordingly, representative information formation may reduce information complexity without requiring direct constitution of associative memory bodies.

In some embodiments, one or more identity structures may be constituted according to one or more representative information structures.

Identity structures may define one or more distinguishable entities associated with one or more representative information structures.

An identity structure may correspond to one or more physical entities, logical entities, computational entities, software entities, hardware entities, operational entities, organizational entities, memory entities, artificial-intelligence entities, human entities, infrastructure entities, or combinations thereof.

For example, identity structures may correspond to one or more sensors, vehicles, operators, greenhouse zones, industrial devices, robotic systems, network participants, communication participants, military targets, operational assets, medical entities, cybersecurity entities, or combinations thereof.

The disclosed architecture is not limited to any particular identity category.

In some embodiments, multiple representative information structures may participate in constitution of a common identity structure.

In other embodiments, one representative information structure may participate in constitution of multiple identity structures.

Identity structures may therefore establish continuity relationships associated with subsequent state constitution relationships.

Accordingly, identity constitution may provide constitutional continuity that permits one or more states, relationships, attributes, verification structures, qualification structures, associative memory bodies, and executable experience structures to remain associated with identifiable entities across time.

Identity structures therefore provide one example of a constitutional foundation upon which governed associative memory-body constitution may occur.

In some embodiments, one or more state structures may be constituted according to one or more identity structures and one or more representative information structures.

The disclosed architecture recognizes that information and states are not equivalent.

Raw information structures may contain observations, measurements, signals, events, records, expressions, or combinations thereof.

State structures may instead represent one or more identifiable conditions associated with one or more identities.

Accordingly, constitution of one or more state structures may transform information-oriented representations into condition-oriented representations.

In some embodiments, one or more state structures may define operational conditions, environmental conditions, behavioral conditions, functional conditions, mission conditions, process conditions, control conditions, communication conditions, security conditions, health conditions, or combinations thereof.

For example, greenhouse information may participate in constitution of states associated with cooling conditions, heating conditions, humidity-management conditions, carbon-dioxide management conditions, light-management conditions, growth conditions, or combinations thereof.

Similarly, autonomous-vehicle information may participate in constitution of states associated with navigation conditions, obstacle-detection conditions, route-following conditions, emergency-response conditions, or combinations thereof.

Military information may participate in constitution of states associated with target-detection conditions, target-tracking conditions, threat conditions, engagement conditions, surveillance conditions, or combinations thereof.

The disclosed architecture is not limited to any particular state taxonomy.

In some embodiments, multiple representative information structures may participate in constitution of a common state structure.

In other embodiments, a single representative information structure may participate in constitution of multiple state structures.

Accordingly, state constitution may reduce dependence upon individual information records while preserving meaningful operational conditions associated with one or more identities.

In some embodiments, one or more relationship structures may be constituted according to one or more state structures.

The disclosed architecture recognizes that isolated states may possess limited constitutional significance.

Additional constitutional significance may arise from relationships among states.

Accordingly, one or more relationship structures may define associations among one or more state structures.

Relationship structures may comprise lineage relationships, association relationships, transition relationships, dependency relationships, causality relationships, temporal relationships, participation relationships, governance relationships, verification relationships, qualification relationships, or combinations thereof.

For example, a first state associated with carbon-dioxide increase may participate in a causality relationship with a second state associated with crop-yield increase.

Similarly, a first state associated with threat detection may participate in a transition relationship with a second state associated with target tracking.

A first state associated with system overheating may participate in a dependency relationship with a second state associated with emergency cooling.

The disclosed architecture is not limited to any particular relationship type.

In some embodiments, relationship structures may preserve historical evolution relationships associated with one or more states.

In some embodiments, relationship structures may preserve future participation relationships associated with one or more states.

Accordingly, relationship constitution may permit state structures to participate in larger constitutional contexts extending beyond isolated observations.

In some embodiments, one or more attribute structures may be constituted according to one or more state structures and one or more relationship structures.

The disclosed architecture recognizes that multiple states may share common constitutional characteristics despite differences in operational details.

Accordingly, attribute constitution may normalize one or more related state structures into one or more higher-order attribute structures.

For example, night-cooling states, emergency-cooling states, seasonal-cooling states, and recovery-cooling states may participate in constitution of a cooling attribute.

Similarly, morning-heating states, recovery-heating states, and maintenance-heating states may participate in constitution of a heating attribute.

The disclosed architecture therefore permits one or more state structures to participate simultaneously within one or more attribute structures.

Attribute constitution does not require deletion of state structures.

Attribute constitution does not require replacement of state structures.

Rather, state structures may continue to exist while simultaneously participating in constitution of one or more higher-order attribute structures.

Accordingly, attribute constitution may be understood as normalization rather than elimination.

In some embodiments, attribute structures may comprise functional attributes, outcome attributes, boundary attributes, verification attributes, temporal attributes, contextual attributes, identity attributes, mission-derived attributes, emergent-meaning attributes, or combinations thereof.

The disclosed architecture is not limited to any specific attribute ontology, attribute taxonomy, attribute hierarchy, attribute model, or attribute representation methodology.

In some embodiments, multiple state structures may participate in constitution of a common attribute structure.

In some embodiments, a single state structure may participate in constitution of multiple attribute structures.

Accordingly, attribute constitution may permit higher-order interpretation of operational conditions while preserving participation of underlying state structures.

The disclosed architecture therefore permits transformation of large quantities of state information into normalized constitutional representations capable of subsequent participation within associative memory-body constitution relationships.

In some embodiments, one or more verification structures may be determined according to one or more identity structures, state structures, relationship structures, attribute structures, or combinations thereof.

The disclosed architecture recognizes that constitution of states, relationships, and

attributes does not inherently establish trustworthiness, admissibility, correctness, reliability, authority, or future participation eligibility.

Accordingly, one or more verification structures may be constituted to determine whether one or more constitutional structures satisfy one or more governance-conditioned verification relationships.

Verification structures may comprise confidence structures, provenance structures, lineage structures, validation structures, authority structures, verification-history structures, consistency structures, continuity structures, corroboration structures, or combinations thereof.

In some embodiments, verification structures may determine whether one or more states are supported by sufficient information.

In some embodiments, verification structures may determine whether one or more relationships are supported by sufficient evidence.

In some embodiments, verification structures may determine whether one or more attributes remain consistent with one or more mission structures, mission boundaries, participation relationships, or combinations thereof.

For example, multiple independent observations may participate in constitution of one or more corroborating verification structures.

Similarly, one or more lineage structures may establish traceability relationships associated with evolution of one or more states, relationships, attributes, or combinations thereof.

In some embodiments, verification structures may preserve historical verification relationships associated with one or more constitutional structures.

Accordingly, verification constitution may establish constitutional trust relationships that extend beyond existence of information alone.

The disclosed architecture therefore recognizes that availability of information does not inherently establish validity of memory participation.

In some embodiments, one or more qualification structures may be determined according to one or more verification structures.

The disclosed architecture recognizes that verification and qualification are not equivalent.

Verification structures may determine whether supporting evidence exists.

Qualification structures may determine whether participation is permitted.

Accordingly, qualification structures may define constitutional admissibility relationships associated with participation of information, identities, states, relationships, attributes, or combinations thereof within associative memory-body constitution relationships.

Qualification structures may comprise admissibility structures, eligibility structures, participation structures, mission-compatibility structures, boundary-compatibility structures, verification-compatibility structures, governance structures, or combinations thereof.

In some embodiments, a verified structure may nevertheless remain unqualified for participation.

For example, information may be accurate yet remain outside one or more mission boundaries.

Similarly, information may be verified yet remain inconsistent with one or more mission objectives.

Accordingly, qualification determination may occur independently from verification determination.

The disclosed architecture therefore recognizes that admissibility is not established solely by correctness.

Rather, admissibility may be established according to mission-governed participation relationships.

In some embodiments, qualification structures may exclude information associated with mission incompatibility, participation incompatibility, boundary incompatibility, verification incompatibility, governance incompatibility, or combinations thereof.

Accordingly, qualification constitution may reduce participation of drifted information, irrelevant information, conflicting information, unverifiable information, mission-incompatible information, boundary-violating information, or combinations thereof.

The disclosed architecture therefore provides governance-conditioned participation control prior to constitution of one or more associative memory bodies.

In some embodiments, one or more governed associative memory bodies may be constituted according to one or more qualification structures, verification structures, identity structures, state structures, relationship structures, attribute structures, or combinations thereof.

The disclosed architecture recognizes that memory is not equivalent to information.

The disclosed architecture further recognizes that memory is not equivalent to isolated states, isolated attributes, isolated relationships, isolated observations, database records, knowledge-graph nodes, machine-learning outputs, or combinations thereof.

Instead, a governed associative memory body may comprise a constitutional structure formed from multiple governance-conditioned constitutional relationships.

In some embodiments, a governed associative memory body may comprise one or more identity structures, one or more state structures, one or more relationship structures, one or more attribute structures, one or more verification structures, one or more qualification structures, or combinations thereof.

Accordingly, a governed associative memory body may preserve not only what exists, but also how it exists, why it exists, how it was verified, how it qualified for participation, and how it relates to other constitutional structures.

In some embodiments, governed associative memory bodies may preserve operational experiences associated with one or more missions.

In some embodiments, governed associative memory bodies may preserve successful outcomes associated with one or more missions.

In some embodiments, governed associative memory bodies may preserve unsuccessful outcomes associated with one or more missions.

Accordingly, the disclosed architecture permits preservation of both positive and negative operational experiences.

The disclosed architecture therefore recognizes that memory significance is not determined solely by frequency of occurrence.

Instead, memory significance may be determined according to mission relevance, verification relationships, qualification relationships, participation relationships, boundary relationships, governance relationships, or combinations thereof.

In some embodiments, constitution of governed associative memory bodies may transform large quantities of information, states, relationships, and attributes into governed memory entities capable of future participation.

Accordingly, governed associative memory bodies may function as reusable constitutional memory assets.

The disclosed architecture therefore differs from conventional information-storage systems because participation within memory constitution relationships is governed prior to establishment of memory existence.

As a result, constitution of memory may occur according to governance-conditioned admissibility relationships rather than according to information availability alone.

In some embodiments, one or more governed associative memory bodies may participate in constitution of one or more associative memory structures.

The disclosed architecture recognizes that operational experience is rarely represented by isolated memories.

Instead, operational experience frequently emerges from interactions among multiple memory bodies associated with different identities, states, relationships, attributes, missions, contexts, or combinations thereof.

Accordingly, one or more associative relationships may be established among multiple governed associative memory bodies.

In some embodiments, associative relationships may comprise lineage relationships, similarity relationships, dependency relationships, causality relationships, temporal relationships, contextual relationships, mission relationships, participation relationships, verification relationships, qualification relationships, or combinations thereof.

The disclosed architecture is not limited to any specific associative methodology.

Accordingly, multiple governed associative memory bodies may participate in constitution of one or more associative memory meshes.

An associative memory mesh may comprise interconnected memory bodies capable of participating in future memory activation relationships.

For example, a greenhouse memory body associated with cooling operations may participate in associative relationships with memory bodies associated with humidity management, carbon-dioxide management, crop growth, energy consumption, or combinations thereof.

Similarly, a military target-tracking memory body may participate in associative relationships with memory bodies associated with surveillance operations, threat assessments, engagement histories, communication activities, operational outcomes, or combinations thereof.

The disclosed architecture therefore permits memory significance to emerge not only from individual memory bodies but also from relationships among memory bodies.

Accordingly, associative memory meshes may preserve constitutional knowledge extending beyond isolated memory entities.

In some embodiments, one or more associative memory bodies may participate in memory activation relationships.

The disclosed architecture recognizes that future operational situations may exhibit similarities to previously experienced situations.

Accordingly, one or more current states, identities, relationships, attributes, verification structures, qualification structures, mission structures, or combinations thereof may activate one or more associative memory bodies.

Activation may occur according to similarity relationships, contextual relationships, mission relationships, operational relationships, temporal relationships, verification relationships, qualification relationships, or combinations thereof.

The disclosed architecture does not require exact matching between current operational conditions and historical memory bodies.

Instead, one or more associative relationships may permit partial activation, contextual activation, mission-governed activation, or combinations thereof.

Accordingly, previously constituted memory bodies may participate in future operational activities without requiring complete reconstruction from raw information.

In some embodiments, one or more activated associative memory bodies may participate in memory reuse relationships.

The disclosed architecture recognizes that repeated reconstruction of operational knowledge from raw information may increase computational cost, increase uncertainty, increase inconsistency, and increase risk of operational drift.

Accordingly, previously constituted associative memory bodies may be reused when one or more mission-governed participation conditions are satisfied.

Memory reuse may comprise state reuse, relationship reuse, attribute reuse, verification reuse, qualification reuse, experience reuse, operational reuse, decision-support reuse, reasoning reuse, or combinations thereof.

In some embodiments, memory reuse may reduce computational effort associated with repeated evaluation of substantially similar operational conditions.

In some embodiments, memory reuse may improve consistency of operational responses across multiple missions.

Accordingly, associative memory bodies may function as reusable constitutional assets capable of future participation.

In some embodiments, one or more executable experience structures may be constituted according to one or more associative memory bodies, associative memory meshes, activation relationships, memory reuse relationships, or combinations thereof.

The disclosed architecture recognizes that operational experience may represent a higher-order constitutional structure derived from memory participation.

Accordingly, executable experience structures may represent operationally usable expressions of previously constituted memory bodies.

Executable experience structures may comprise recommendation structures, reasoning-support structures, validation-support structures, guidance structures, control structures, decision-support structures, operational-expression structures, or combinations thereof.

In some embodiments, executable experience structures may provide mission-relevant outputs without requiring direct participation of all underlying raw information structures.

Instead, executable experience structures may participate according to governance-conditioned memory relationships.

Accordingly, executable experience structures may provide reusable operational knowledge while preserving traceability to underlying verification structures, qualification structures, associative memory bodies, and associated constitutional relationships.

In some embodiments, executable experience structures may participate in reasoning-support relationships.

The disclosed architecture recognizes that reasoning may benefit from previously verified and qualified memory participation.

Accordingly, reasoning support may occur through activation and participation of one or more associative memory bodies and one or more associative memory meshes.

Reasoning support may comprise hypothesis evaluation, operational assessment, anomaly interpretation, prediction support, explanation support, planning support, mission-support activities, or combinations thereof.

The disclosed architecture therefore permits reasoning activities to participate according to governed memory relationships rather than solely according to newly generated computational outputs.

In some embodiments, executable experience structures may participate in decision-support relationships.

Decision-support participation may comprise evaluation of operational alternatives, prioritization of actions, assessment of risks, assessment of opportunities, mission planning, operational planning, control planning, resource planning, or combinations thereof.

In some embodiments, multiple associative memory bodies may simultaneously participate in constitution of one or more decision-support outputs.

Accordingly, decision-support participation may benefit from accumulated operational experiences preserved within associative memory bodies and associative memory meshes.

In some embodiments, the disclosed architecture may reduce participation of drifted information within future operational activities.

The disclosed architecture recognizes that artificial-intelligence outputs, computational outputs, inferred outputs, generated outputs, predicted outputs, or combinations thereof may exhibit inconsistency, uncertainty, contradiction, mission incompatibility, boundary incompatibility, verification incompatibility, qualification incompatibility, or combinations thereof.

Accordingly, participation within associative memory-body constitution relationships may be conditioned upon mission-governed verification and qualification relationships.

Because memory participation is constrained by mission structures, mission boundaries, verification structures, qualification structures, and governance relationships, constitution of associative memory bodies may reduce uncontrolled participation of drifted information.

The disclosed architecture therefore differs from systems that permit unrestricted participation of generated information.

Instead, participation authority may be determined according to governance-conditioned admissibility relationships.

Accordingly, future reasoning, decision support, guidance, validation, control, and operational activities may be performed using associative memory bodies that have previously satisfied verification and qualification relationships.

The disclosed architecture therefore provides a mission-governed associative memory-body constitution framework configured to support reusable operational knowledge while reducing participation of unverified, unqualified, mission-incompatible, boundary-violating, or otherwise inadmissible information structures.

In one non-limiting embodiment, the disclosed architecture may be applied to greenhouse climate management and crop-production optimization.

One or more raw information structures may comprise temperature information, humidity information, carbon-dioxide information, lighting information, irrigation information, energy-consumption information, crop-growth information, equipment-status information, environmental information, or combinations thereof.

One or more mission structures may define crop-yield objectives, resource-efficiency objectives, environmental-control objectives, energy-efficiency objectives, operational constraints, quality requirements, or combinations thereof.

Mission boundaries may determine which information structures are eligible for participation in associative memory-body constitution relationships.

Representative information structures may be formed from large quantities of greenhouse observations through one or more reduction, aggregation, clustering, abstraction, summarization, or representative-information formation operations.

One or more identity structures may be constituted for greenhouse zones, crop regions, climate-control devices, environmental-control systems, irrigation systems, or combinations thereof.

One or more state structures may be constituted for cooling conditions, heating conditions, humidity-management conditions, carbon-dioxide management conditions, light-management conditions, crop-growth conditions, resource-consumption conditions, or combinations thereof.

One or more relationship structures may be constituted among the state structures.

For example, carbon-dioxide management states may participate in relationships associated with crop-growth states.

Humidity-management states may participate in relationships associated with disease-control states.

Cooling states may participate in relationships associated with energy-consumption states.

One or more attribute structures may be constituted from multiple state structures and relationship structures.

For example, multiple cooling-related states may participate in constitution of a cooling attribute.

Multiple growth-related states may participate in constitution of a crop-development attribute.

Verification structures may determine reliability of one or more observations and constitutional relationships.

Qualification structures may determine whether one or more constitutional structures are admissible for participation in memory constitution.

Accordingly, one or more governed associative memory bodies may be constituted that preserve operational experiences associated with greenhouse management.

The associative memory bodies may subsequently participate in memory activation, memory reuse, reasoning support, decision-support participation, guidance participation, control participation, executable-experience constitution, or combinations thereof.

In one non-limiting embodiment, the disclosed architecture may be applied to autonomous-vehicle operations.

Raw information structures may comprise camera information, lidar information, radar information, positioning information, navigation information, motion information, environmental information, traffic information, vehicle-status information, or combinations thereof.

One or more mission structures may define safe-navigation objectives, route-completion objectives, collision-avoidance objectives, operational constraints, passenger-safety requirements, traffic-compliance requirements, or combinations thereof.

Representative information structures may be formed from one or more raw information structures.

Identity structures may be constituted for vehicles, pedestrians, obstacles, road segments, traffic-control devices, infrastructure assets, or combinations thereof.

State structures may comprise navigation states, obstacle-detection states, route-following states, emergency-response states, traffic-interaction states, pedestrian-interaction states, or combinations thereof.

Relationship structures may define dependencies, transitions, temporal relationships, causality relationships, or combinations thereof among one or more states.

Attribute structures may normalize multiple operational states into higher-order attributes associated with navigation, safety, mobility, obstacle management, traffic compliance, or combinations thereof.

Verification structures may determine confidence associated with observations and relationships.

Qualification structures may determine whether one or more constitutional structures are admissible for participation in memory constitution relationships.

One or more governed associative memory bodies may therefore preserve reusable operational experiences associated with vehicle operation.

Executable experience structures may subsequently participate in route planning, obstacle avoidance, safety guidance, operational reasoning, decision support, or combinations thereof.

In one non-limiting embodiment, the disclosed architecture may be applied to industrial-process control environments.

Raw information structures may comprise sensor information, equipment information, production information, process information, quality information, maintenance information, environmental information, operational information, or combinations thereof.

Mission structures may define production-quality objectives, efficiency objectives, reliability objectives, throughput objectives, safety objectives, regulatory objectives, or combinations thereof.

Identity structures may be constituted for equipment, production lines, facilities, operators, process segments, quality-control systems, or combinations thereof.

State structures may comprise operating states, maintenance states, fault states, recovery states, efficiency states, production states, quality states, or combinations thereof.

Relationship structures may define interactions among equipment conditions, process conditions, production outcomes, quality outcomes, maintenance outcomes, or combinations thereof.

Attribute structures may normalize recurring operational conditions into higher-order operational attributes.

Verification structures may determine validity of observations and operational relationships.

Qualification structures may determine admissibility of constitutional participation.

Accordingly, one or more associative memory bodies may preserve reusable operational experiences associated with industrial control.

Executable experience structures may participate in fault prevention, maintenance planning, production optimization, quality improvement, operational guidance, decision support, or combinations thereof.

In one non-limiting embodiment, the disclosed architecture may be applied to command, control, communications, computers, intelligence, surveillance, and reconnaissance environments.

Raw information structures may comprise radar information, electro-optical information, infrared information, communication information, intelligence information, surveillance information, reconnaissance information, operational reports, sensor information, or combinations thereof.

One or more mission structures may define target-identification objectives, threat-assessment objectives, operational-awareness objectives, force-protection objectives, mission-success objectives, operational constraints, engagement constraints, or combinations thereof.

Mission boundaries may determine admissibility of information participation according to mission relevance.

Identity structures may be constituted for targets, platforms, operators, sensors, operational assets, communication assets, infrastructure assets, or combinations thereof.

State structures may comprise detection states, tracking states, classification states, surveillance states, threat states, engagement states, communication states, operational-awareness states, or combinations thereof.

Relationship structures may define transitions among operational states, dependencies among operational assets, temporal relationships, causality relationships, mission relationships, verification relationships, or combinations thereof.

Attribute structures may normalize operational conditions into higher-order threat attributes, surveillance attributes, engagement attributes, operational-awareness attributes, communication attributes, mission attributes, or combinations thereof.

Verification structures may evaluate corroboration among multiple information sources.

Qualification structures may determine whether information is admissible for operational participation.

Accordingly, one or more governed associative memory bodies may be constituted that preserve verified and qualified operational experiences.

Associative memory meshes may preserve relationships among multiple operational experiences across multiple missions.

Executable experience structures may participate in operational planning, threat assessment, target evaluation, mission support, operational reasoning, decision support, guidance participation, control participation, or combinations thereof.

The disclosed architecture therefore permits mission-governed transformation of heterogeneous operational information into reusable associative memory bodies and executable experience structures capable of supporting future operational activities.

In one non-limiting embodiment, the disclosed architecture may be applied to artificial-intelligence reasoning environments.

Raw information structures may comprise sensor information, textual information, image information, audio information, video information, communication information, database information, model-generated information, inferred information, predicted information, artificial-intelligence outputs, or combinations thereof.

One or more mission structures may define question-answering objectives, planning objectives, operational-support objectives, analysis objectives, reasoning objectives, validation objectives, decision-support objectives, or combinations thereof.

Mission boundaries may determine admissibility of information participation according to mission relevance.

Representative information structures may be formed from one or more heterogeneous information sources.

Identity structures may be constituted for participants, entities, assets, operational objects, information sources, computational structures, artificial-intelligence structures, or combinations thereof.

State structures may comprise operational states, assessment states, prediction states, anomaly states, planning states, reasoning states, recommendation states, uncertainty states, or combinations thereof.

Relationship structures may define dependencies, correlations, causal relationships, temporal relationships, verification relationships, contradiction relationships, qualification relationships, or combinations thereof.

Attribute structures may normalize multiple reasoning states into higher-order reasoning attributes, planning attributes, assessment attributes, confidence attributes, mission attributes, or combinations thereof.

Verification structures may evaluate consistency, corroboration, provenance, lineage, authority, confidence, or combinations thereof.

Qualification structures may determine whether one or more artificial-intelligence outputs are admissible for participation in associative memory-body constitution relationships.

Accordingly, generated information may not automatically participate in memory constitution relationships.

Instead, participation may occur according to mission-governed verification and qualification relationships.

One or more associative memory bodies may therefore preserve verified and qualified reasoning experiences.

Executable experience structures may subsequently participate in future reasoning activities without requiring unrestricted participation of newly generated outputs.

Accordingly, the disclosed architecture may reduce participation of drifted artificial-intelligence outputs by requiring mission-governed admissibility relationships prior to memory constitution.

In one non-limiting embodiment, the disclosed architecture may be applied to humanoid robotic systems.

Raw information structures may comprise visual information, audio information, tactile information, force information, pressure information, proximity information, motion information, positional information, environmental information, operational information, or combinations thereof.

One or more mission structures may define object-manipulation objectives, navigation objectives, human-assistance objectives, safety objectives, operational objectives, learning objectives, task-completion objectives, or combinations thereof.

Mission structures may determine which sensory information participates in memory constitution relationships.

Accordingly, different missions may activate different participation boundaries.

For example, a manipulation mission may emphasize visual information, tactile information, force information, and positional information.

A navigation mission may emphasize visual information, environmental information, obstacle information, and motion information.

An interaction mission may emphasize visual information, audio information, language information, and contextual information.

Representative information structures may be formed from one or more sensory observations.

Identity structures may be constituted for objects, persons, locations, tools, robotic components, environmental entities, operational entities, or combinations thereof.

State structures may comprise grasping states, manipulation states, navigation states, obstacle states, interaction states, balance states, operational states, learning states, or combinations thereof.

Relationship structures may define interactions among actions, outcomes, objects, environmental conditions, operational conditions, or combinations thereof.

Attribute structures may normalize operational experiences into manipulation attributes, navigation attributes, interaction attributes, safety attributes, task-completion attributes, or combinations thereof.

Verification structures may determine reliability of sensory observations and operational outcomes.

Qualification structures may determine admissibility of participation within associative memory-body constitution relationships.

Accordingly, one or more associative memory bodies may preserve reusable robotic experiences.

Executable experience structures may subsequently participate in future object manipulation, navigation, interaction, planning, control, guidance, or combinations thereof.

In one non-limiting embodiment, the disclosed architecture may be applied to medical decision-support environments.

Raw information structures may comprise patient information, physiological information, laboratory information, imaging information, treatment information, medication information, outcome information, historical information, clinical observations, or combinations thereof.

One or more mission structures may define diagnostic objectives, treatment objectives, risk-reduction objectives, outcome-improvement objectives, monitoring objectives, clinical constraints, regulatory constraints, or combinations thereof.

Identity structures may be constituted for patients, treatments, conditions, procedures, medications, clinical entities, healthcare providers, or combinations thereof.

State structures may comprise diagnostic states, treatment states, monitoring states, recovery states, deterioration states, intervention states, outcome states, or combinations thereof.

Relationship structures may define interactions among conditions, treatments, outcomes, risks, interventions, observations, or combinations thereof.

Attribute structures may normalize medical experiences into treatment attributes, outcome attributes, risk attributes, recovery attributes, diagnostic attributes, or combinations thereof.

Verification structures may evaluate reliability, provenance, corroboration, consistency, authority, validation, or combinations thereof.

Qualification structures may determine admissibility of participation within associative memory-body constitution relationships.

Accordingly, one or more associative memory bodies may preserve verified and qualified clinical experiences.

Executable experience structures may subsequently participate in diagnostic support, treatment support, risk assessment, monitoring support, planning support, outcome evaluation, or combinations thereof.

In one non-limiting embodiment, the disclosed architecture may be applied to cybersecurity and intrusion-detection environments.

Raw information structures may comprise network information, communication information, authentication information, access information, event information, alert information, system information, user information, threat information, security information, or combinations thereof.

One or more mission structures may define intrusion-detection objectives, threat-identification objectives, infrastructure-protection objectives, resilience objectives, operational-continuity objectives, security constraints, or combinations thereof.

Identity structures may be constituted for users, devices, systems, applications, network entities, threat entities, operational assets, infrastructure assets, or combinations thereof.

State structures may comprise normal-operation states, anomaly states, intrusion states, attack states, reconnaissance states, compromise states, recovery states, mitigation states, or combinations thereof.

Relationship structures may define attack relationships, dependency relationships, propagation relationships, causality relationships, temporal relationships, verification relationships, qualification relationships, or combinations thereof.

Attribute structures may normalize operational security experiences into threat attributes, vulnerability attributes, attack attributes, resilience attributes, recovery attributes, mitigation attributes, or combinations thereof.

Verification structures may evaluate corroboration among multiple security observations and threat indicators.

Qualification structures may determine admissibility of participation within associative memory-body constitution relationships.

Accordingly, one or more associative memory bodies may preserve verified and qualified cybersecurity experiences.

Associative memory meshes may preserve relationships among multiple attacks, mitigations, responses, outcomes, and operational histories.

Executable experience structures may subsequently participate in intrusion detection, threat assessment, response planning, mitigation planning, operational guidance, decision support, resilience planning, or combinations thereof.

The disclosed architecture therefore permits mission-governed transformation of cybersecurity information into reusable associative memory bodies and executable experience structures capable of supporting future security operations.

The disclosed architecture is not limited to any particular information source, sensory source, computational source, operational source, communication source, storage source, software implementation, hardware implementation, mathematical implementation, artificial-intelligence implementation, machine-learning implementation, governance implementation, or deployment environment.

Raw information structures may comprise visual information, audio information, tactile information, radar information, lidar information, communication information, environmental information, biological information, industrial information, operational information, artificial-intelligence information, human-generated information, machine-generated information, future information types, or combinations thereof.

Mission structures may comprise one or more expected outcomes, objectives, purposes, constraints, priorities, participation conditions, operating conditions, verification conditions, qualification conditions, boundary conditions, or combinations thereof.

Mission boundaries may be static, dynamic, adaptive, context-dependent, mission-dependent, operator-defined, automatically determined, computationally determined, governance-determined, or combinations thereof.

Representative information formation may comprise compression operations, abstraction operations, aggregation operations, clustering operations, reduction operations, normalization operations, representative-selection operations, summarization operations, or combinations thereof.

In some embodiments, one or more representative information structures may be formed according to one or more observation intervals.

In some embodiments, one or more representative information structures may be formed according to one or more temporal participation intervals.

In some embodiments, one or more representative information structures may be formed according to one or more selective temporal participation intervals.

Accordingly, information associated with different temporal participation intervals may participate in constitution of different states, relationships, attributes, associative memory bodies, executable experiences, or combinations thereof.

The disclosed architecture is therefore not limited to any particular temporal participation methodology.

Associative memory bodies may be represented as memory structures, graph structures, vector structures, mathematical structures, equation structures, function structures, executable structures, symbolic structures, hybrid structures, future representation structures, or combinations thereof.

Executable experience structures may participate in reasoning activities, decision-support activities, planning activities, control activities, guidance activities, validation activities, assessment activities, prediction activities, future operational activities, or combinations thereof.

Accordingly, the disclosed architecture encompasses mission-governed transformation of raw information into governed associative memory bodies and executable experience structures across heterogeneous operational environments.

In some embodiments, the disclosed architecture recognizes that raw information and memory are not equivalent.

Raw information may represent observations, measurements, signals, expressions, records, communications, sensor outputs, computational outputs, artificial-intelligence outputs, or combinations thereof.

Memory may instead represent one or more governance-conditioned constitutional structures formed according to mission-governed participation relationships.

Accordingly, the disclosed architecture does not require direct preservation of all raw information structures in order to constitute one or more associative memory bodies.

Instead, one or more associative memory bodies may preserve constitutional significance derived from information participation relationships.

The disclosed architecture therefore recognizes that memory significance may arise from mission relevance, state participation, relationship participation, attribute participation, verification participation, qualification participation, governance participation, or combinations thereof.

Accordingly, memory constitution may differ from information accumulation.

In some embodiments, mission structures may establish one or more constitutional boundaries associated with memory formation.

The disclosed architecture recognizes that identical information may possess different constitutional significance under different missions.

Accordingly, mission boundaries may determine admissibility of participation of one or more information structures.

For example, information relevant to greenhouse climate optimization may possess limited significance within a military target-identification mission.

Similarly, information relevant to medical diagnosis may possess limited significance within an industrial-control mission.

Accordingly, memory formation may be mission-dependent.

The disclosed architecture therefore recognizes that mission determination may precede memory determination.

Mission structures may therefore function as constitutional origin structures for subsequent associative memory-body constitution relationships.

In some embodiments, memory constitution may occur through multiple constitutional layers.

Information structures may participate in constitution of state structures.

State structures may participate in constitution of relationship structures.

Relationship structures may participate in constitution of attribute structures.

Verified and qualified constitutional structures may subsequently participate in constitution of associative memory bodies.

Accordingly, memory constitution may occur through progressive abstraction relationships.

The disclosed architecture therefore recognizes that memory may emerge from participation among multiple constitutional structures rather than from information storage alone.

In some embodiments, multiple state structures may participate in constitution of one or more higher-order attribute structures.

Attribute constitution may therefore reduce constitutional complexity while preserving constitutional meaning.

The disclosed architecture recognizes that normalization is not equivalent to deletion. Accordingly, state structures may continue to exist while simultaneously participating in

one or more attribute structures.

For example, multiple cooling-related states may participate in constitution of a cooling attribute.

Multiple navigation-related states may participate in constitution of a navigation attribute.

Multiple threat-related states may participate in constitution of a threat attribute. Accordingly, attribute structures may preserve higher-order meaning while permitting

preservation of underlying state structures.

In some embodiments, memory participation may be conditioned upon verification and qualification relationships.

The disclosed architecture recognizes that information correctness alone does not establish memory admissibility.

Similarly, information availability alone does not establish memory admissibility.

Accordingly, verification structures and qualification structures may operate together to determine participation eligibility.

The disclosed architecture therefore distinguishes:
Information
Verified Information
Qualified Information
Governed Associative Memory Bodies
as constitutionally different structures.

Accordingly, memory constitution may occur only after satisfaction of governance-conditioned participation requirements.

In some embodiments, one or more associative memory bodies may participate in associative relationships with one another.

The disclosed architecture recognizes that operational experience frequently exists as interconnected memory structures rather than isolated memory structures.

Accordingly, memory significance may arise from relationships among memory bodies.

Associative memory meshes may therefore preserve higher-order operational knowledge extending beyond individual memory bodies.

The disclosed architecture therefore recognizes that memory relationships may themselves possess constitutional significance.

In some embodiments, associative memory bodies may participate in constitution of executable experience structures.

Executable experience structures may permit reuse of previously constituted operational knowledge.

Accordingly, future operational activities may benefit from previously verified and qualified experiences.

The disclosed architecture therefore recognizes that memory may participate directly in reasoning, planning, guidance, validation, decision-support, control, and future operational activities.

In some embodiments, the disclosed architecture may emulate one or more aspects of biological memory formation.

One or more sensory inputs may participate in formation of representative information structures.

Representative information structures may participate in constitution of identities, states, relationships, attributes, verification structures, qualification structures, associative memory bodies, and executable experience structures.

Different missions may emphasize participation of different sensory inputs.

Accordingly, visual information, audio information, tactile information, environmental information, communication information, or combinations thereof may participate differently according to mission requirements.

The disclosed architecture therefore recognizes that memory significance may depend upon mission-governed participation rather than sensory acquisition alone.

The mathematical formulations presented herein are exemplary only and are provided solely to illustrate example constitutional relationships associated with mission-governed associative memory-body constitution.

The disclosed architecture is not limited to any particular equation, function, mathematical representation, statistical representation, graph representation, ontology representation, optimization methodology, artificial-intelligence methodology, machine-learning methodology, symbolic methodology, probabilistic methodology, computational methodology, or implementation methodology.

One or more alternative formulations, equivalent formulations, modified formulations, future formulations, or combinations thereof may be utilized.

Any formulation capable of establishing mission-governed associative memory-body constitution relationships may be utilized.

One or more mission structures may be represented as:

M={O,G,C,P,PC,OC,VC,BC}

where:
M=Mission Structure
O=Expected Outcomes
G=Objectives
C=Constraints
P=Priorities
PC=Participation Conditions
OC=Operating Conditions
VC=Verification Conditions
BC=Boundary Conditions

One example mission-boundary formulation may be represented as:

B=Fb(M)

where:
B=Mission Boundary
Fb=Mission-Boundary Function
M=Mission Structure

Let:

R={r1,r2, . . . ,rn}
represent a raw-information universe.

One example mission-governed participation formulation may be represented as:

P=φ(R,M,B)

where:
P=Participating Information Set
φ=Mission-Governed Participation Function
R=Raw Information Universe
M=Mission Structure
B=Mission Boundary

One example admissibility formulation may be represented as:

P={ri∈R|G(ri,M,B)=1}

where:
G=Mission Admissibility Function

One example representative-information formulation may be represented as:

Rp=Fr(P)

where:
Rp=Representative Information Set
Fr=Representative Information Formation Function
P=Participating Information Set

The representative-information formation function may preserve constitutional significance while reducing information complexity.

The disclosed architecture does not require any particular compression ratio and remains consistent with information-theoretic constraints.

One example identity constitution formulation may be represented as:

I=Fi(Rp)

where:
I=Identity Structure Set
Fi=Identity Constitution Function
Rp=Representative Information Set

One example state constitution formulation may be represented as:

S=Fs(I,Rp,ΔTn)

where:
S=State Structure Set
Fs=State Constitution Function
I=Identity Structure Set
Rp=Representative Information Set
ΔTn=Selective Temporal Participation Interval

In some embodiments:

Sj=Fs(Ii,Rpi,ΔTn)

where:
Sj=State j
Ii=Identity i
Rpi=Representative Information Structure i

In some embodiments:

ΔT=Observation Interval

ΔTn=Selective Temporal Participation Interval
where:

ΔTn⊆ΔT

One or more state structures may therefore be constituted according to selective participation intervals rather than entire observation intervals.

Accordingly, different temporal participation intervals may participate in constitution of different meanings, states, relationships, attributes, associative memory bodies, executable experiences, or combinations thereof.

One example relationship constitution formulation may be represented as:

Rel=Frel(S)

where:
Rel=Relationship Structure Set
Frel=Relationship Constitution Function
S=State Structure Set

In some embodiments:

Relij=Frel(Si,Sj)

where:
Relij=Relationship Between States i and j
Si=State i
Sj=State j

One example attribute constitution formulation may be represented as:

A=Fa(S,Rel)

where:
A=Attribute Structure Set
Fa=Attribute Constitution Function
S=State Structure Set
Rel=Relationship Structure Set

One example normalization formulation may be represented as:

Ak=N(S1,S2, . . . ,Sn)

where:
Ak=Attribute k
N=Attribute Normalization Function
S1 . . . . Sn=Participating State Structures

One example weighted attribute formulation may be represented as:

Ak=Σwi Si

where:
wi=State Participation Weight
Si=Participating State

The disclosed architecture is not limited to weighted formulations.

Alternative normalization methodologies, abstraction methodologies, ontology methodologies, clustering methodologies, semantic methodologies, machine-learning methodologies, statistical methodologies, or combinations thereof may be utilized.

One example attribute evolution formulation may be represented as:

A(t+1)=Fa(A(t),ΔS)

where:
A(t)=Attribute at Time t
A(t+1)=Attribute at Time t+1
ΔS=State Participation Change

One example verification formulation may be represented as:

V=Fv(E,L,P,C)

where:
V=Verification Structure
Fv=Verification Function
E=Evidence
L=Lineage
P=Provenance
C=Consistency

One example verification weighting formulation may be represented as:

V=αE+βL+γP+δC

where:
α, β, γ, and δ represent weighting factors.

One example qualification formulation may be represented as:

Q=Fq(V,M,B)

where:
Q=Qualification Structure
Fq=Qualification Function
V=Verification Structure
M=Mission Structure
B=Mission Boundary

One example qualification determination formulation may be represented as:

Q=1

if:

V≥Vmin
and
Mission Compatible
and
Boundary Compatible
otherwise:
Q=0

One example associative memory-body formulation may be represented as:

MB={I,S,Rel,A,V,Q}

where:
MB=Associative Memory Body
I=Identity Structures
S=State Structures
Rel=Relationship Structures
A=Attribute Structures
V=Verification Structures
Q=Qualification Structures

One example associative memory-body constitution formulation may be represented as:

MB=Fm(I,S,Rel,A,V,Q)

where:
Fm=Associative Memory-Body Constitution Function

One example associative memory mesh formulation may be represented as:

MM=Graph(MBi,Eij)

where:
MM=Associative Memory Mesh
MBi=Associative Memory Body i
Eij=Associative Relationship Between Memory Bodies

One example memory activation formulation may be represented as:

Act=Fact(MM,Ctx,M)

where:
Act=Activated Memory Set
Fact=Memory Activation Function
MM=Associative Memory Mesh
Ctx=Operational Context
M=Mission Structure

One example executable-experience formulation may be represented as:

EE=Fe(MM,M)

where:
EE=Executable Experience Structure
Fe=Executable Experience Constitution Function
MM=Associative Memory Mesh
M=Mission Structure

One example unified constitutional formulation may be represented as:

P=φ(R,M,B)

Rp=Fr(P)

I=Fi(Rp)

S=Fs(I,Rp,ΔTn)

Rel=Frel(S)

A=Fa(S,Rel)

V=Fv(E,L,P,C)

Q=Fq(V,M,B)

MB=Fm(I,S,Rel,A,V,Q)

MM=Graph(MBi,Eij)

EE=Fe(MM,M)

The foregoing formulations are exemplary only.

The disclosed architecture is not limited to any particular mathematical formulation and encompasses alternative formulations capable of establishing mission-governed associative memory-body constitution relationships.

The definitions provided herein are intended solely to facilitate understanding of example embodiments of the disclosed subject matter.

The disclosed subject matter is not limited to the specific wording of the definitions provided herein.

Unless explicitly stated otherwise, the defined terms may encompass equivalent structures, future structures, alternative structures, modified structures, extensions thereof, or combinations thereof.

A mission structure is a structure configured to define one or more expected outcomes, objectives, purposes, constraints, priorities, participation conditions, operating conditions, verification conditions, boundary conditions, or combinations thereof.

A mission structure establishes constitutional context associated with subsequent participation, memory formation, verification, qualification, associative-memory constitution, executable-experience constitution, or combinations thereof.

A mission boundary is a structure configured to determine admissibility of participation according to one or more mission structures.

Mission boundaries may define inclusion relationships, exclusion relationships, relevance relationships, participation relationships, admissibility relationships, governance relationships, or combinations thereof.

Mission boundaries may be static, dynamic, adaptive, context-dependent, mission-dependent, automatically determined, manually determined, governance-determined, or combinations thereof.

A participation structure is a structure configured to determine whether one or more information structures, identities, states, relationships, attributes, verification structures, qualification structures, memory structures, executable-experience structures, or combinations thereof are permitted to participate in one or more constitutional relationships.

Participation is not established solely according to existence of information.

Participation may be established according to mission-governed admissibility relationships.

A memory candidate is a structure capable of participating in one or more subsequent identity constitution relationships, state constitution relationships, relationship constitution relationships, attribute constitution relationships, verification determination relationships, qualification determination relationships, associative memory-body constitution relationships, executable-experience constitution relationships, or combinations thereof.

A memory candidate is not necessarily an associative memory body.

A memory candidate may comprise one or more representative information structures, identity structures, state structures, relationship structures, attribute structures, verification structures, qualification structures, or combinations thereof.

Participation of a memory candidate within associative memory-body constitution relationships may be conditioned according to mission-governed participation relationships, verification relationships, qualification relationships, governance relationships, or combinations thereof.

A representative information structure is an information structure formed from one or more participating information structures.

Representative information structures may comprise compressed information, aggregated information, clustered information, normalized information, abstracted information, summarized information, selected information, reduced information, transformed information, or combinations thereof.

Representative information structures are not required to preserve all underlying raw information structures.

A representative information structure may function as a memory candidate for participation within one or more subsequent associative memory-body constitution relationships.

An identity structure is a structure configured to establish identifiable constitutional existence associated with one or more entities.

Identity structures may be associated with persons, devices, systems, software structures, hardware structures, operational assets, organizations, artificial-intelligence structures, memory structures, infrastructure structures, environmental structures, future entities, or combinations thereof.

A state structure is a structure configured to represent one or more identifiable conditions associated with one or more identities.

State structures may comprise operational conditions, environmental conditions, behavioral conditions, process conditions, mission conditions, control conditions, communication conditions, security conditions, health conditions, functional conditions, or combinations thereof.

A state structure is not required to be equivalent to one or more raw information structures.

A relationship structure is a structure configured to establish one or more constitutional relationships among one or more states, identities, attributes, memory bodies, executable experiences, or combinations thereof.

Relationship structures may comprise temporal relationships, lineage relationships, association relationships, dependency relationships, causality relationships, participation relationships, governance relationships, verification relationships, qualification relationships, or combinations thereof.

An attribute structure is a structure constituted according to one or more state structures, relationship structures, or combinations thereof.

Attribute structures may represent higher-order constitutional characteristics associated with one or more participating state structures.

Attribute constitution may comprise normalization, abstraction, categorization, grouping, clustering, semantic determination, ontology determination, feature determination, machine-learning determination, statistical determination, or combinations thereof.

Attribute structures do not require elimination of participating state structures.

A verification structure is a structure configured to determine trust relationships associated with one or more identities, states, relationships, attributes, memory bodies, executable experiences, or combinations thereof.

Verification structures may comprise confidence relationships, evidence relationships, provenance relationships, lineage relationships, corroboration relationships, validation relationships, consistency relationships, authority relationships, or combinations thereof.

Verification does not inherently establish participation admissibility.

A qualification structure is a structure configured to determine admissibility of participation according to one or more verification structures, mission structures, mission boundaries, governance relationships, or combinations thereof.

Qualification structures may establish eligibility relationships, admissibility relationships, participation relationships, mission-compatibility relationships, boundary-compatibility relationships, governance relationships, or combinations thereof.

Qualification is constitutionally distinct from verification.

A structure may be verified without being qualified.

An associative memory body is a governance-conditioned constitutional memory structure constituted according to one or more identity structures, state structures, relationship structures, attribute structures, verification structures, qualification structures, or combinations thereof.

An associative memory body is not required to be equivalent to raw information, database records, isolated states, isolated attributes, isolated relationships, artificial-intelligence outputs, machine-learning outputs, knowledge-graph nodes, or combinations thereof.

An associative memory body may preserve constitutional significance associated with operational experiences, mission experiences, verification relationships, qualification relationships, participation relationships, governance relationships, or combinations thereof.

A governed associative memory body is an associative memory body whose participation is conditioned according to mission-governed verification relationships, qualification relationships, admissibility relationships, governance relationships, boundary relationships, or combinations thereof.

An associative memory mesh is a structure comprising one or more associative memory bodies and one or more associative relationships among the associative memory bodies.

Associative relationships may comprise similarity relationships, dependency relationships, temporal relationships, causality relationships, mission relationships, contextual relationships, verification relationships, qualification relationships, participation relationships, governance relationships, or combinations thereof.

An associative memory mesh may preserve constitutional knowledge extending beyond individual associative memory bodies.

Memory activation is participation of one or more associative memory bodies according to one or more current contexts, missions, states, relationships, attributes, verification structures, qualification structures, or combinations thereof.

Memory activation may comprise contextual activation, mission activation, similarity activation, partial activation, associative activation, governance-conditioned activation, or combinations thereof.

An executable experience structure is a structure constituted according to one or more associative memory bodies, associative memory meshes, memory activations, verification relationships, qualification relationships, mission relationships, or combinations thereof.

Executable experience structures may comprise reasoning-support structures, recommendation structures, guidance structures, decision-support structures, validation-support structures, control structures, planning-support structures, operational-expression structures, or combinations thereof.

An executable experience structure may participate in future operational activities according to governance-conditioned participation relationships.

Memory significance refers to constitutional significance associated with one or more associative memory bodies.

Memory significance may be determined according to mission relevance, state participation, relationship participation, attribute participation, verification relationships, qualification relationships, governance relationships, operational outcomes, temporal persistence, or combinations thereof.

Memory significance is not required to be determined solely according to information quantity, storage quantity, occurrence frequency, communication activity, computational activity, or combinations thereof.

A selective temporal participation interval is a temporal participation interval utilized for constitution of one or more states, relationships, attributes, associative memory bodies, executable experiences, or combinations thereof.

Selective temporal participation intervals may represent subsets of larger observation intervals.

Different selective temporal participation intervals may participate in constitution of different meanings, states, attributes, memory bodies, executable experiences, or combinations thereof.

Mission-governed associative memory-body constitution refers to transformation of raw information into associative memory bodies according to mission structures, mission boundaries, participation structures, representative information structures, identity structures, state structures, relationship structures, attribute structures, verification structures, qualification structures, governance relationships, or combinations thereof.

The disclosed architecture is not limited to any particular implementation methodology and encompasses alternative structures capable of establishing mission-governed associative memory-body constitution relationships.

1. A governed associative memory-body constitution system comprising one or more information-processing entities configured to:
receive one or more raw information structures;
determine one or more mission structures associated with the one or more raw information structures;
determine one or more mission boundaries according to the one or more mission structures;
determine one or more participation structures according to the one or more mission boundaries;
form one or more representative information structures from the one or more raw information structures according to the one or more participation structures;
constitute one or more identity structures associated with the one or more representative information structures;
constitute one or more state structures associated with the one or more identity structures;
constitute one or more relationship structures associated with the one or more state structures;
constitute one or more attribute structures associated with the one or more state structures and the one or more relationship structures;
determine one or more verification structures associated with the one or more identity structures, state structures, relationship structures, and attribute structures;
determine one or more qualification structures according to the one or more verification structures;
constitute one or more governed associative memory bodies according to the one or more qualification structures and the one or more verification structures;
constitute one or more associative-memory structures associated with the one or more governed associative memory bodies;
constitute one or more executable experience structures from the one or more governed associative memory bodies;
wherein the one or more mission structures determine one or more mission boundaries, the one or more mission boundaries determine one or more participation structures, the one or more participation structures determine eligibility of information for participation in constitution of the one or more governed associative memory bodies, and the one or more governed associative memory bodies determine constitution of one or more executable experience structures.

2. The system of claim 1, wherein the mission structures comprise one or more machine-processable objective structures, purpose structures, constraint structures, priority structures, participation-condition structures, operating-condition structures, boundary-condition structures, verification-condition structures, or combinations thereof.

3. The system of claim 1, wherein the representative information structures are formed through one or more reduction operations, compression operations, abstraction operations, clustering operations, aggregation operations, filtering operations, selection operations, summarization operations, representative-information extraction operations, representative-information formation operations, or combinations thereof.

4. The system of claim 1, wherein the relationship structures comprise one or more lineage relationships, association relationships, transition relationships, dependency relationships, causality relationships, temporal relationships, participation relationships, governance relationships, or combinations thereof.

5. The system of claim 1, wherein the attribute structures comprise one or more memory-derived attribute structures constituted from one or more state structures, relationship structures, verification structures, memory structures, or combinations thereof.

6. The system of claim 5, wherein one or more attribute structures are constituted according to associative relationships among governed associative memory bodies.

7. The system of claim 1, wherein the mission boundaries comprise one or more observation boundaries, participation boundaries, state boundaries, qualification boundaries, verification boundaries, memory boundaries, association boundaries, executable-experience boundaries, or combinations thereof.

8. A method for constituting one or more governed associative memory bodies, comprising:
receiving one or more raw information structures;
determining one or more mission structures;
determining one or more mission boundaries;
determining one or more participation structures;
forming one or more representative information structures;
constituting one or more identity structures;
constituting one or more state structures;
constituting one or more relationship structures;
constituting one or more attribute structures;
determining one or more verification structures;
determining one or more qualification structures;
constituting one or more governed associative memory bodies;
constituting one or more associative-memory structures associated with the one or more governed associative memory bodies;
and constituting one or more executable experience structures according to the one or more governed associative memory bodies.

9. The method of claim 8, wherein determining the qualification structures comprises determining admissibility relationships associated with participation of information in constitution of the governed associative memory bodies.

10. The method of claim 8, wherein determining the qualification structures comprises constraining participation of drifted, inconsistent, unverifiable, conflicting, boundary-violating, mission-incompatible, or otherwise unqualified information structures.

11. The method of claim 8, further comprising determining one or more verification structures associated with the governed associative memory bodies.

12. The method of claim 8, wherein one or more shorter observation windows operate concurrently with one or more longer observation windows to preserve localized events, anomalies, mutations, transitions, or combinations thereof.

13. The method of claim 8, wherein identical raw information structures constitute different governed associative memory bodies according to different mission structures and different mission boundaries.

14. The method of claim 8, wherein the governed associative memory bodies are constituted according to one or more mission-governed participation relationships.

15. A governed associative memory body comprising:
one or more identity structures;
one or more qualified participation structures;
one or more qualified state structures;
one or more qualified relationship structures;
one or more qualified attribute structures;
one or more boundary structures including one or more memory-boundary structures;
one or more verification structures;
one or more associative-memory structures;
and one or more executable experience structures;
wherein the governed associative memory body is constituted from one or more raw information structures through mission-governed participation, representative-information formation, state constitution, relationship constitution, attribute constitution, verification determination, qualification determination, associative-memory-body constitution, and executable-experience constitution operations.

16. The governed associative memory body of claim 15, wherein the verification structures comprise confidence structures, provenance structures, lineage structures, validation structures, authority structures, verification-history structures, or combinations thereof.

17. The governed associative memory body of claim 15, wherein the associative-memory structures constitute an associative memory mesh comprising interconnected governed associative memory bodies.

18. The governed associative memory body of claim 15, wherein the executable experience structures comprise structured operational expressions configured for recommendation generation, decision-support participation, reasoning participation, validation participation, memory reuse participation, future participation, control participation, guidance participation, or combinations thereof.

19. The governed associative memory body of claim 15, wherein the attribute structures comprise one or more functional attributes, outcome attributes, boundary attributes, verification attributes, temporal attributes, contextual attributes, identity attributes, mission-derived attributes, emergent-meaning attributes, or combinations thereof.

20. The governed associative memory body of claim 15, wherein the governed associative memory body comprises a structured executable experience-memory object configured for associative participation, future reuse, validation, verification, reasoning support, operational guidance, decision-support participation, or combinations thereof.
